(19) United States
(12) Patent Application Publication
(10) Pub. No.: US 2024/0208323 A1
(43) Pub. Date: Jun. 27, 2024

(54) FLUSH FLAP OF A FRONT FACE ASSEMBLY

(71) Applicant: Valeo Systemes Thermiques, Le Mesnil Saint Denis (FR)

(72) Inventors: Shankar Duraisamy, Chennai (IN); Arunkumar Subramanian, Chennai (IN); Sebastien Velasco, Chennai (IN); Parthasarathy Raghavan, Chennai (IN); Arulkumaran Mohan, Chennai (IN)

(73) Assignee: Valeo Systemes Thermiques, Le Mesnil Saint Denis (FR)

(21) Appl. No.: 18/396,096

(22) Filed: Dec. 26, 2023

(30) Foreign Application Priority Data
Dec. 23, 2022 (FR) 2214368

(51) Int. Cl. B60K 11/08

(52) U.S. Cl. CPC B60K 11/085

(57) ABSTRACT

The present invention relates to a front face assembly configured to be fitted in a motor vehicle. The front face assembly includes a screen and a shut-off device. The screen includes at least one passage via which an air flow can pass through the screen. The shut-off device includes at least one flap adapted to take up a first position in which the flap shuts off the passage and a second position in which the flap opens the passage. The flap includes a shut-off element which extends at least partially in the passage in the screen when the flap is in its first position.

The present invention relates to the field of thermal management devices, and more particularly a front face assembly of a vehicle intended to have an air flow passing through it.

Vehicles, notably motor vehicles, are commonly equipped with a front face assembly adapted to have an air flow passing through it. This air flow is used, for example, to perform heat exchange with a front face heat exchanger so as to operate an air-conditioning and/or cooling system or a radiator. Such front face assemblies may include systems for controlling this air flow, generally referred to as AGS, which stands for Active Grille Shutter. They make it possible in particular to increase the air penetration coefficient when the engine does not need to be cooled by an external air flow, which makes it possible to reduce fuel consumption and vehicle emissions.

These air flow control systems are generally composed of a screen in which passages are made to allow the air flow to pass through. The system further comprises a shut-off device composed, for example, of flaps controlled by a control unit so as to allow or prevent the passage of the air flow through the passages made in the screen, in particular to reduce the air penetration coefficient when the flaps prevent the passage of the air flow.

These shut-off devices have a first drawback. To be specific, sealing between the screen and the flaps needs to be improved.

Another drawback of these shut-off devices is that they are not very aesthetically pleasing and in particular form a surface over the whole of the front face having many reliefs. The present invention falls within this context and proposes overcoming at least the abovementioned drawback by means of a front face assembly having a smooth surface, in which the distinction between the flaps and the passages in the screen is barely discernible.

Thus, the present invention relates to a front face assembly intended to be fitted in a motor vehicle, the front face assembly comprising a screen and a shut-off device, the screen comprising at least one passage via which an air flow can pass through the screen, the shut-off device comprising at least one flap adapted to take up a first position in which the flap shuts off the passage and a second position in which the flap opens the passage, the flap comprising a shut-off element which extends at least partially in the passage in the screen when the flap is in its first position.

The shut-off element extends in the passage of the screen such that the air flow cannot enter via said passage. Sealing of the front face assembly is thus improved.

Note that when the flap is in its first position, it is configured such that at least part of the whole space, advantageously all of the space, defined by the passage is blocked by the shut-off element.

According to one feature of the invention, the screen is delimited by a first face and a second face, the passage extending between the first face and the second face, the shut-off element of the flap lying flush with one of said faces of the screen.

The shut-off element and the passage have a similar dimension such that when the shut-off element is fully inside the passage, then the shut-off element of the flap lies flush with one of said faces of the screen.

According to one feature of the invention, the flap has a contact face intended to come into contact with a face of the screen which is opposite the face with which the portion of the flap lies flush. The shut-off element protrudes from this contact face. Note that when the shut-off element has a dimension identical to the length of the passage and when the contact face of the flap is in contact with a face of the screen, the shut-off element lies flush with the opposite face of the screen.

According to one feature of the invention, the screen comprises a support portion, said support portion forming the part of the screen distinct from the at least one passage, the contact face of the flap coming into contact with said support portion.

According to one feature of the invention, the shut-off element of the flap which extends in the passage in the screen has a shape complementary to said passage.

According to one feature of the invention, the shut-off element protrudes from the contact face of the flap.

According to one feature of the invention, the flap comprises a rotation shaft and a control pin, the front face assembly comprising at least one lever connected to the at least one flap by the control pin, the levier being movable in translation so as to change the position of the flap.

According to one feature of the invention, the at least one flap comprises a plurality of shut-off elements, the screen comprising a plurality of passages, at least one of the shut-off elements being intended to extend in one of the passages dedicated to the shut-off element.

According to one feature of the invention, the shut-off device comprises a plurality of flaps, at least two of the flaps going simultaneously from their first position to their second position. Each flap is connected to the lever; the movement of the lever thus causes the movement of each flap. Advantageously, all of the flaps move simultaneously.

According to one feature of the invention, the front face assembly comprises at least one lighting device adapted to take up a first configuration in which the lighting device is in line with the passage and a second configuration in which the lighting device is in line with the support portion of the screen.

The invention also relates to a motor vehicle comprising a front face assembly intended to have an air flow passing through it and in accordance with any one of the above features.

Other features, details and advantages of the invention will become more clearly apparent from reading the following description and from exemplary embodiments provided by way of non-limiting indication with reference to the accompanying schematic drawings, in which:

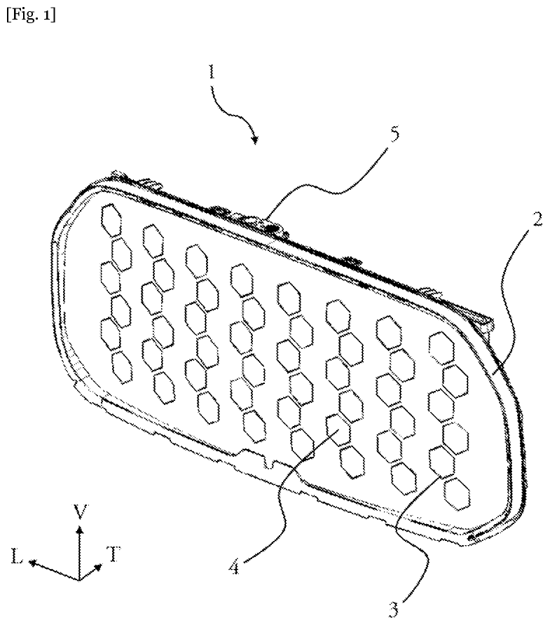

FIG. 1 is an end-on view of a front face assembly intended to be fitted in a vehicle, and in accordance with the invention;

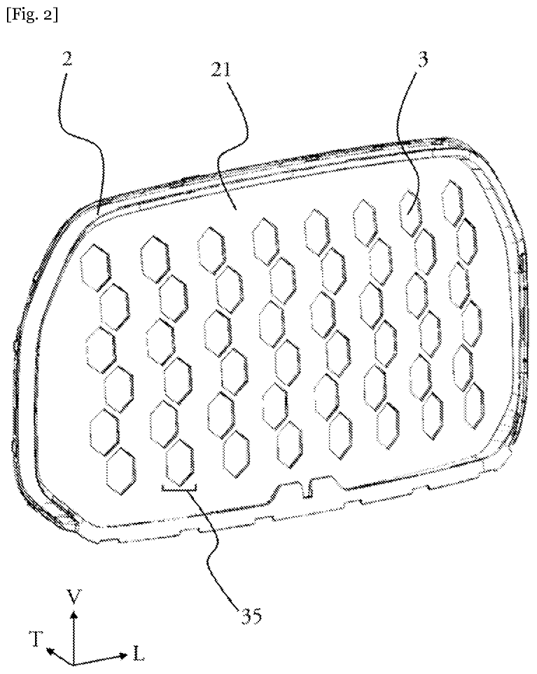

FIG. 2 shows a screen of the front face assembly visible in FIG. 1, isolated from the other elements of the front face assembly;

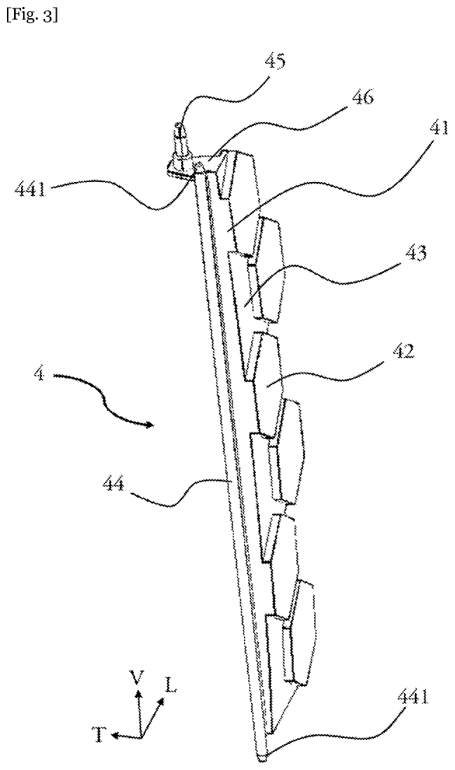

FIG. 3 shows a shut-off device of the front face assembly visible in FIG. 1, isolated from the other elements of the front face assembly;

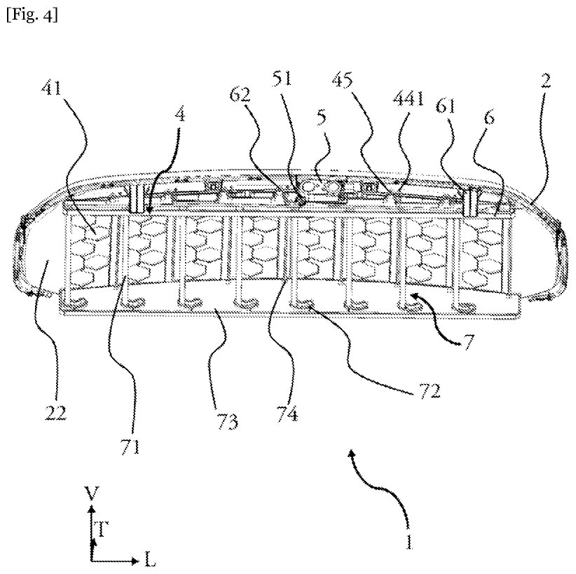

FIG. 4 shows a rear view of the front face assembly visible in FIG. 1;

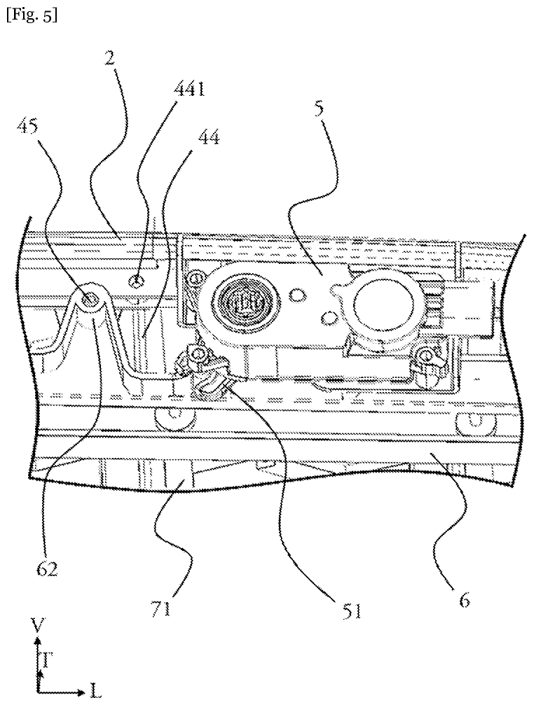

FIG. 5 shows an enlargement of an actuation device intended for controlling at least one flap of the front face assembly.

Firstly, it must be noted that although the figures disclose the invention in detail for the implementation thereof, they can of course be used to further define the invention if applicable. It should also be noted that these figures merely disclose exemplary embodiments of the invention.

The features, variants and different embodiments of the invention may be associated with one another, in various combinations, provided that they are not mutually incompatible or exclusive. It is in particular possible to imagine variants of the invention that comprise only a selection of the features described below, in isolation from the other features described, if this selection of features is sufficient to confer a technical advantage or to differentiate the invention from the prior art.

In the figures, elements that are common to multiple figures retain the same reference sign.

FIG. 1 depicts a front face assembly 1 intended to be fitted in a vehicle, and more specifically a motor vehicle. The front face assembly 1 is for example a front grille.

The front face assembly 1 has a screen 2 in which is made at least one passage 3 via which an air flow can pass through the screen 2 so as to enter the engine compartment of the vehicle. As can be seen in FIG. 1, this passage 3 is obstructed by a shut-off device 4 which will be described in more detail with reference to FIGS. 3 and 4. The shut-off device 4 is controlled by a control unit, not shown, commanding an actuation device 5 which will be described in more detail with reference to FIG. 5. However, as can be seen in FIG. 1, the shut-off element 4 and an outer face of the screen 2 extend in the same plane and this is why it is considered that the shut-off device comprises a shut-off element which lies flush with said screen, on the outside of the latter.

FIG. 2 depicts more specifically the screen 2 of the front face assembly 1. This screen 2 has a first face 21 delimiting the screen 2 and via which the air flow is able to enter the engine compartment of the vehicle when the front face assembly 1 is fitted in said vehicle. Opposite the first face 21, the screen 2 is delimited by a second face 22, visible in FIG. 4. Moreover, the screen 2 comprises, in the embodiment shown, a plurality of passages 3, each passage 3 extending between the first face 21 and the second face 22 of the screen 2.

As can be seen in FIG. 2, the passages 3 are distributed in series 35 along the screen 2 in a longitudinal direction parallel to the axis L at equal distances from one another, each of these series 35 of passages 3 extends in a vertical direction parallel to the axis V. Moreover, in the embodiment shown, each series 35 comprises six passages 3. It should be noted that, in an alternative embodiment, the series 35 may comprise a different number of passages 3. Furthermore, these series 35 may each comprise a different number of passages 3 from one series 35 to another.

The passages 3 advantageously have a regular hexagonal shape, the dimensions of the sides of which are similar from one passage 3 to another of the same series 35. Such a repetition of shapes makes it possible to arrange the passages 3 in a regular pattern, in other words alternating regularly, making it possible to homogenize the circulation of the air flow through the screen 2.

FIG. 3 depicts a flap 41 of the shut-off device 4. This flap 41 extends, like the series of passages 3, mainly in the vertical direction, parallel to the axis V. Note that a single flap 41 is shown in FIG. 3 but, in the embodiment illustrated, the shut-off device 4 comprises a plurality of flaps 41, and more particularly a number of flaps 41 equal to the number of series 35 of passages 3 in the screen 2.

It will be understood from the above that a flap 41 of the shut-off device 4 is advantageously configured to be complementary with a series 35 of passages 3. To this end, the flap 41 comprises at least one shut-off element 42. In the embodiment shown, each flap 41 comprises a plurality of shut-off elements 42. More specifically, each flap 41 comprises a number of shut-off elements 42 equal to the number of passages 3 of the series 35 with which the flap 41 is associated. In other words, the flap 41 comprises six shut-off elements 42, each shut-off element 42 being intended to shut off one of the six passages 3 of the associated series 35. Note that “associated” means that the flap 41 is directly intended to shut off the passages 3 of the series 35 with which the flap 41 is complementary.

The shut-off elements 42 are housed in the passages 3. Thus, the shut-off elements 42 have a shape complementary to the shape of the passages 3. These similar shapes between the shut-off element 42 and the passage 3 allow the shut-off element 42 to penetrate the passage 3. More specifically, the shut-off element 42 penetrates the passage 3 in such a way that a contact face 43 of the flap 41 comes into contact with the second face 22 of the screen 2. This second face 22 comprises a support portion, distinct from the passages 3, the contact face 43 of the flap 41 coming into contact with this support portion.

The shut-off elements 42 protrude from said contact face 43 of the flap 41 over a dimension equal to the distance separating the first face 21 and the second face 22 of the screen 2. Note that when the contact face 43 of the flap 41 comes into contact with the second face 22 of the screen 2, and more specifically with the support portion of the second face 22, the shut-off elements 42 are then flush with the first face 21 of the screen 2.

It should be noted that each shut-off element 42 has a free end or free face at a distance from the part of the shut-off element 42 which starts on the contact face 43. This free end of the shut-off element 42 extends in a plane of extension coincident with the plane of extension of the first face 21 of the screen 2 at the passage 3 associated with said shut-off element 42 when the shut-off element 42 shuts off the passage and the contact face 43 is in contact with the second face 22 of the screen 2.

Moreover, this flap 41 is adapted to take up a first position in which at least one of the series of passages 3 is shut off by the flap 41, in other words circulation of the air flow through the screen 2 is prevented by the flap 41, and a second position in which the flap 41 opens the passage 3, in other words circulation of the air flow through the screen 2 is permitted by the flap 41. The flaps 41 are rotatable between their first position and their second position. In the first position of the flaps 41, the shut-off elements 42 extend at least partially in passages 3 that are distinct from one another. The shut-off elements 42 then being flush with the first face 21 of the screen 2, the contact face 43 comes into contact with the second face 22 of the screen 2 opposite the first face 21.

This change of position of the flap 41 is permitted by a rotation shaft 44 extending on a longitudinal edge of the flap 41 from one vertical end to the other. This rotation shaft 44 comprises at each end, rotation pins 441 which are housed in rotation bearings formed in the screen 2, in such a way as to allow the rotation of the flap 41 about an axis which passes through the rotation shaft 44.

The flap 41 further comprises a control pin 45 formed at at least one of the vertical ends of the flap 41. More specifically, this control pin 45 is formed on a tab 46 extending perpendicularly to the contact face 43. The control pin 45 is housed in a bearing of a control lever, as will be described in more detail with reference to FIGS. 4 and 5, the passage of the flap 41 from its first position to its second position, and vice versa, being caused by operation of the lever.

FIGS. 4 and 5 respectively show a rear view of the front face assembly 1 and a view focused on the actuation device 5.

As can be seen in FIG. 4, the flaps 41 are in their first position in which the flaps 41 shut off the series 35 and the associated passages 3. More specifically, the second face 22 of the screen 2 can be seen in FIG. 4. As shown in this FIG. 4, the front face assembly 1 comprises a plurality of flaps 41 distributed in the longitudinal direction of extension of the screen 2.

The flaps 41 are connected to a lever 6 movable in translation in the longitudinal direction. In the embodiment shown, the lever 6 is blocked in the vertical direction and in the transverse direction, parallel to the axis T, by retention elements 61. These retention elements 61 are secured to the screen 2 and prevent the lever 6 from moving in the transverse and vertical directions, while allowing the lever 6 to move in the longitudinal direction.

The lever 6 comprises a bearing 62 in which the control pin 45 is housed. The lever 6 is connected to the flaps 41 by means of the control pin 45 of each flap and the associated bearing 62. The translational movement of the lever 6 causes the control pin 45 of each flap 41 to move. More generally, it will be appreciated that the translational movement of the lever 6 makes the flaps 41 go from one of their positions to the other.

To allow translational movement of the lever 6, the actuation device 5 comprises a fork 51 configured to cause the lever 6 to move in translation. As can be seen in particular in FIG. 5, the fork 51 is engaged on an element of the lever 6 in such a way that a movement of the fork 51 causes the lever 6 to move in translation; the control pin 45 in engagement in the bearing 62 of the lever 6 accompanies the translational movement of the lever 6 by a rotation of the flap about the rotation shaft 44.

Furthermore, the front face assembly 1 comprises a light emitting means 7 comprising at least one lighting device 71. In the embodiment shown, the light emitting means 7 comprises a plurality of lighting devices 71, and more particularly a number of lighting devices 71 equal to the number of flaps 41 and hence to the number of series 35.

These lighting devices 71 extend, like the series 35 and the flaps 41, mainly in a vertical direction. Each lighting device 71 is adapted to take up a first configuration in which the lighting device 71 is in line with the passage 3, in other words in the embodiment shown in line with the series 35 of passages 3, and a second configuration, visible in FIG. 4, in which the lighting device 71 is in line with the support portion of the screen 2.

Like the flaps 41, the passage from one configuration to the other is commanded by the lever 6 and thus controlled by the actuation device 5. To this end, each lighting device 71 is secured to the lever 6 via a vertical end of the lighting device 71. The opposite end of the lighting devices 71 travels inside a groove 72 acting as a guide for the lighting devices 71. Each lighting device 71 travels in a separate groove 72.

The grooves 72 are formed in a guide portion 73 extending in the longitudinal direction perpendicularly to the vertical direction at an end of the lighting devices opposite the lever 6. This guide portion 73 comprises a plurality of bearings 74 making it possible to keep, together with the screen 2, the rotation pins 441 in a fixed position so as to ensure the change of position of the flaps 41.

The present invention clearly achieves the aim set by proposing a front face assembly in which the face via which the air flow is intended to enter forms a sealed and advantageously smooth surface when the flaps are in a position preventing the passage of the air flow through the screen. Such a face of the front face assembly cleverly conceals the passages made in the screen when the flap is in said position in which it prevents the passage of the air flow.

1. A front face assembly configured to be fitted in a motor vehicle, the front face assembly comprising:
a screen; and
a shut-off device,
the screen comprising at least one passage via which an air flow can pass through the screen,
the shut-off device comprising at least one flap adapted to take up a first position in which the flap shuts off the passage and a second position in which the flap opens the passage,
the flap comprising a shut-off element which extends at least partially in the passage in the screen when the flap is in its first position.

2. The front face assembly according to claim 1,
wherein the screen is delimited by a first face and a second face,
wherein the passage extends between the first face and the second face,
wherein the shut-off element of the flap lies flush with one of the faces of the screen.

3. The front face assembly according to claim 2,
wherein the flap comprises a contact face configured to come into contact with a face of the screen which is opposite the face with which the portion of the flap lies flush.

4. The front face assembly according to claim 3,
wherein the screen comprises a support portion,
wherein the support portion forms the part of the screen distinct from the at least one passage,
wherein the contact face of the flap comes into contact with the support portion.

5. The front face assembly according to claim 1,
wherein the shut-off element of the flap which extends in the passage in the screen is of a shape complementary to the passage.

6. The front face assembly according to claim 3,
wherein the shut-off element protrudes from the contact face of the flap.

7. The front face assembly according to claim 1,
wherein the flap comprises a rotation shaft and a control pin,
wherein the front face assembly comprises at least one lever connected to the at least one flap by the control pin,
wherein the lever is movable in translation so as to change the position of the flap.

8. The front face assembly according to claim 1,
wherein the at least one flap comprises a plurality of shut-off elements,
wherein the screen comprises a plurality of passages,
wherein at least one of the shut-off elements is configured to extend in one of the passages dedicated to the shut-off element.

9. The front face assembly according to claim 1,
wherein the shut-off device comprises a plurality of flaps,
wherein at least two of the flaps are configured to go simultaneously from their first position to their second position.

10. The front face assembly according to claim 4,
comprising at least one lighting device adapted to take up a first configuration in which the lighting device is in line with the passage, and
wherein the lighting device is adapted to take up a second configuration in which the lighting device is in line with the support portion of the screen.

11. A motor vehicle comprising the front face assembly according to claim 1,
wherein the front face assembly is configured to accept an air flow passing through it.
